(19) United States
(12) Patent Application Publication
(10) Pub. No.: US 2020/0095517 A1
(43) Pub. Date: Mar. 26, 2020

(54) Methods For Bio-Oil Recovery

(71) Applicant: Buckman Laboratories International, Inc., Memphis, TN (US)

(72) Inventors: Percy A. Jaquess, Memphis, TN (US); Mark L. Reed, Memphis, TN (US); Sveinn J. Storm, Memphis, TN (US); Dimitri Kouznetsov, Memphis, TN (US)

(73) Assignee: Buckman Laboratories International, Inc., Memphis, TN (US)

(21) Appl. No.: 16/554,739

(22) Filed: Aug. 29, 2019

Related U.S. Application Data
(60) Provisional application No. 62/736,755, filed on Sep. 26, 2018.

(51) Int. Cl. C11B 1/10; C11B 1/02

(52) U.S. Cl. CPC C11B 1/10; C12Y 301/01003; C11B 1/025

(57) ABSTRACT

A method for oil recovery from biomass is provided which includes adding at least one lipase classified as EC 3.1.1.3 to a biomass prior to or during a fermenting of the biomass. The method can further include fermenting, recovering stillage and separating oil therefrom.

### BACKGROUND OF THE INVENTION

This application claims the benefit under 35 U.S.C. § 119(e) of prior U.S. Provisional Patent Application No. 62/736,755, filed Sep. 26, 2018, which is incorporated in its entirety by reference herein.

The present invention relates to a method and system for bio-oil recovery. The present invention further relates to processes of extracting and recovering oil from stillage, such as thin stillage and/or syrup that are further products or resulting from a fermentation process.

Ethanol production from biomass has received significant attention in recent years as a source of alternative fuel or biofuel. Ethanol can be produced using renewable resources such as grains or other renewable starch-containing biomass. A widely used method of producing ethanol from grains is known as “dry milling,” and usually is practiced using corn in the United States. In making ethanol from such materials as corn, various steps in a fermentation process are utilized. The starch containing materials, like corn can be subjected to a cleaning step to remove material other than the corn or other starch containing material. The starch containing material can be generally subjected to a milling (e.g., hammermilling) or grinding step to form a milled material. The milling can be dry milling or wet milling. The milled material, when starch based, then needs to be converted to sugars that can be fermented into ethanol. The conversion to sugars can be a multi-step process and can involve forming a slurry of the milled material. The slurry can receive one or more enzymes to provide the conversion to sugars. For instance, an alpha amylase enzyme can be used to convert the starch containing material into dextrins. A cooker can be used to cook the slurry. The introduction or use of an alpha amylase enzyme can be introduced before and/or after the cooker (if one is used). A liquefaction step can then be used for the cooked slurry. A further enzyme can be used and added to the slurry to cause saccharifying of the dextrins to form sugars. The further enzyme can be a carbohydrate generating enzyme such as a glucoamylase. At the same time or after the sugar converting enzyme is added, a fermenting organism, such as yeast, is utilized (e.g., added) to convert the sugars to an alcohol and/or other product. The product resulting from the fermentation process can be referred to as mash or fermented mash or beer mash. The liquid products of the fermentation are recovered from the mash using conventional separation techniques. For instance, the liquid (e.g., ethanol) can be recovered using distillation (one or multiple distillation columns). The remaining non-distilled products, which can be liquids and solids, can be considered or known as whole stillage. The whole stillage can contain a variety of materials including oil and distillers grains. The whole stillage can be subjected to one or more processes to separate a large amount of the liquids from the solids. For instance, a centrifuge is used or centrifugation. The solids or solid phase can be referred to as coarse solids or wet cake or wet distillers grains (or wet grains) and the liquids or liquid phase can be referred to as thin stillage. The coarse solids or wet cake can contain from about 25 wt % to 40 wt % solids and the thin stillage can contain from about 5 wt % to about 15 wt % solids, depending on the separation techniques used. The coarse solids or wet cake can be dried, such as with a rotary dryer, to obtain dry distillers grains (aka distillers dried grains or DDG) and can be used as part of animal feed. As an option, prior to drying, condensed distillers solubles (such as syrup, like corn syrup) can be added to the wet distillers grains and after drying, this is referred to as dry distillers grains plus solubles (aka distillers dried grain with solubles or DDGS). In some processes, the thin stillage or a fraction thereof can be evaporated to provide a condensate, sometimes referred to a condensed distillers solubles and can be syrup. These solubles can be used as stated in the DDG or recycled back to the slurry. FIG. 1 is an example of a process flow diagram of ethanol biofuel and byproducts production from corn (or other fermentable starch-containing biomass) that includes bio-oil recovery from stillage and also shows aspects of the present application.

As part of the process, bio-oil is extracted from the whole stillage and/or thin stillage and/or condensed distillers solubles, which can be used in biodiesel production or other biorenewable products. There is great interest in increasing the amount of oil extracted as this can be more profitable than the ethanol made in the process.

Efforts to recover higher and higher amounts of the valuable oil from stillage have encountered significant obstacles. For example, the previous use of flash point hydrocarbon solvents, alcohols or polyhydroxy alcohols as extraction solvents for bio-oils have drawbacks. These compounds, while effective, require high concentrations for bio-oil separation which results in potential safety issues. Regulatory requirements for animal feed also have precluded use of these compounds in bio-oil separation, especially in corn fermentation. Another approach involves attempting to separate the oil directly from the thin stillage before the evaporation stage, such as using a centrifuge. U.S. Patent Application Publication No. 2007/0238891 shows a method of freeing bound oil present in whole stillage and thin stillage, which involves heating the stillage to a temperature said to be sufficient to at least partially separate oil therefrom for recovery from the stillage.

The present inventors have recognized that there continues to be a need to increase the amount of oil recovered from such processes and that this can occur not only from the use of separation aids added to the stillage but also upstream of this step, such as during or before the fermentation step.

### SUMMARY OF THE PRESENT INVENTION

A feature of the present invention is to provide a method for recovering oil from biomass, such as stillage or fractions thereof.

A further feature of the present invention relates to processes of recovering corn oil or other natural grain oils or bio-oils from industrial fermentation processes and systems.

An additional feature of the present invention is to provide a method for improving or increasing the amount of oil recovery from stillage byproduct of a biomass fermentation process by using a very particular class of enzymes during the earlier fermentation stage, and this eventually leads to a stillage or treated stillage that when oil is recovered from the stillage or treated stillage (such as by centrifuging the stillage) more efficient and/or greater oil separation and recovery occurs.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates, in part, to a method for bio-oil recovery from a fermentation process, comprising adding at least one lipase classified as EC 3.1.1.3 prior to or during the fermenting of a biomass that comprises sugar converted from starch in the biomass, resulting in ethanol and stillage, and recovering the stillage that contains oil, and recovering at least a portion of the oil from the stillage.

As used herein, “bio-oil” refers to food-grade and non-food grade oils and fats that are derived from plants and/or animals (e.g., vegetable oils and animal fats), which contain primarily triglycerides, but can also contain fatty acids, diglycerides and monoglycerides. As used herein, the term “fat” is understood to include “lipids”. Examples of bio-oils derived from plants include, but are not limited to, corn oil, sugarcane oil, sunflower oil, flaxseed oil, canola oil, and the like. Other bio-oils include algaculture bio-oils (from algae).

As used herein, “biofuel” refers to any renewable solid, liquid or gaseous fuel produced biologically, such as bio-oils, including for example, bio-oils derived from biomass. Biofuels also include, but are not limited to, biodiesels, bioethanol (i.e., ethanol), biogasoline, biomethanol, biobutanol, and the like.

As used herein, “biomass” refers generally to organic matter harvested or collected from a renewable biological resource as a source of energy. The renewable biological resource can include plant materials such as starch-containing material like corn (e.g., plant biomass), animal materials, and/or materials produced biologically. The term “biomass” is not considered to include non-renewable fossil fuels, such as coal, petroleum and natural gas, which do not normally include glycerides (e.g., tri-, di-, mono-).

As used herein, “stillage” refers to a co-product or byproduct produced during production of a biofuel. When used without qualification, the term “stillage” can refer to whole stillage, thin stillage, or concentrated stillage such as condensed distillers soluble, i.e., syrup, which can be produced from biofuel process streams, e.g., bioethanol production process streams. The differences between these different forms of stillage can be further understood with reference to FIG. 1 herein.

As used herein, a “centrifuge” is a piece of equipment, generally driven by a motor, that can put a mixture, blend or slurry in rotation around a fixed axis, applying a force perpendicular to the axis. Centripetal acceleration generated in the centrifuge causes denser and lighter substances of the mixture, blend or slurry to separate out. Centrifuges can be oriented horizontally, vertically, or other orientations.

As used herein, an “evaporator” is a device used to evaporate or vaporize the liquid form of a chemical or chemicals in a mixture, blend or slurry into gaseous or vapor form. The evaporation of more volatile components of a mixture, blend or slurry in an evaporator can concentrate the remaining less volatile liquid components in the device.

As used herein, “surfactant” refers to a compound that can lower the surface tension of a liquid, the interfacial tension between two liquids, or that between a liquid and a solid.

As used herein, a “nonionic surfactant” is an organic compound that is amphiphilic and has no charge group at either terminal end group thereof, wherein the organic compound can lower the surface tension of a liquid, the interfacial tension between two liquids, or that between a liquid and a solid.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF DRAWINGS

FIG. 1 is a process flow diagram of ethanol biofuel and byproducts production from corn (or other fermentable starch-containing biomass) that includes bio-oil recovery from stillage in accordance with an example of the present application.

FIG. 2 is a bar graph showing the amounts of corn oil recovered from stillage for a control, and for one example of the present invention, and showing three comparative enzymes (not a lipase of the present invention) used instead during fermentation.

FIG. 3 is a bar graph showing the amounts of corn oil recovered from stillage for a control, and for examples of the present invention, using different ppm dosage levels of the lipase of the present invention.

### DETAILED DESCRIPTION OF THE PRESENT INVENTION

In general, the present invention relates to methods for oil recovery from a fermentation process. The present invention provides or utilizes a particular enzyme, triacylglycerol lipase, for recovery enhancement of grain oil or bio-oil (e.g. corn oil) or mixture of other types of natural grain oils. Particularly, the present invention utilizes or makes use of at least one lipase classified as EC 3.1.1.3 before and/or during the fermentation process. The use of this lipase has the ability and/or leads to the ability to recover bio-oil more efficiently, and/or more effectively, and/or in larger quantities in steps taken downstream of the fermentation step. Due to the present invention with the use of this particular lipase(s), more oil, such as corn oil can be recovered compared to when no such lipase is used. Further, it is believed that this class of lipases is more efficient, more effective, and/or results in the recovery of more oil from a fermentation process compared to other enzymes or lipases not in this EC 3.1.1.3 class. Other properties and/or advantages are further described herein.

The method can include, comprise, consists essentially of, or consists of: adding at least one lipase classified as EC 3.1.1.3 to a biomass (e.g., a slurry of milled grains) prior to and/or during a fermenting of the biomass, wherein said biomass preferably comprises sugar converted from starch in the biomass.

The adding or introduction of the lipase preferably occurs after any dry milling step and before fermentation begins.

The adding or introduction of the lipase preferably occurs after any cooking step and before fermentation begins.

The adding or introduction of the lipase preferably occurs after any liquefaction of the starch, and before fermentation begins.

To obtain the most benefits of the present invention, the lipase is added when the temperature of the mash or biomass is below 80 deg C. (such as below 55 deg C., for instance from about 25 deg C. to about 50 deg C. or from about 30 deg C. to about 40 deg C.). And, preferably, the lipase is added after any liquefaction step and upon achieving the above-mentioned temperature range and prior to the start of fermentation.

The adding or introduction of the lipase can be done prior to, at the same time as, or subsequent to the addition or introduction of either the carbohydrate generating enzyme or fermenting organism, or both. The adding or introduction of the lipase can occur within 5 hours, within 1 hour, within 30 minutes, within 15 minutes, within 5 minutes, within 1 minute, or with 30 seconds of the introduction of either the carbohydrate generating enzyme or fermenting organism, or both.

If the adding or introduction of the lipase occurs during fermentation, preferably the lipase is added before 20 wt % of sugars available are converted to alcohol, such as before 15 wt %, before 10 wt %, before 5 wt %, or before 1 wt %, based on total starting sugars present in the fermenter.

The adding or introduction of the lipase preferably occurs after any liquefaction of the starch from the prepared slurry mash and upon cooling of the mash, so that the mash is at a temperature of from about 10 deg C. to 50 deg C., or from about 15 deg C. to about 45 deg C., such as from about 20 deg C. to 35 deg C.

The lipase remains present during the fermentation cycle of the mash or bio-mass. The lipase preferably acts upon the biomass triglycerides (e.g. grain triglycerides) present prior to any distillation of the mash that contains the converted alcohol.

The use of the EC 3.1.1.3 lipase can be particularly effective in promoting oil separation in a biomass after a biomass fermentation process.

A preferred method of the present invention is where the use of the particular lipase is initiated preferably at the beginning of fermentation by adding it to a mixing tank (with water) to form a lipase containing solution, where the solution is delivered (e.g., by a line pipe) to the fermenter as initiation of (or before) fermentation is started. The fermentation process may usually occur for 55 hours to 70 hours or longer and be maintained at a temperature of from about 30° C. to 35° C. with a pH range of from 4.5 to 5.3. Other temperatures and/or pH ranges outside of these ranges is an option. During this time the fermenting organism (e.g. yeast) converts glucose to ethanol.

In one aspect of the present invention, the lipase acts upon triglycerides present in the biomass (e.g. grain kernels) that has been previously dry milled to the desired particle size of the industrial plant.

The preferred dose of the lipase is from about 0.5 U to about 2 U such as approximately 1.5 U in the vessel fermentation medium. The “U” is an enzyme unit and is a unit for the amount of this particular enzyme. One U is defined as the amount of the enzyme that catalyzes the conversion of 1 micro-mole of triglyceride in the fermentation medium per ml of the mash in the fermenter per minute (and with the temperature conditions during fermentation in the fermenter). As an option, more than 2 U of lipase can be used. As an option, 0.1 U to 0.5 U of lipase can be used.

The use of this type of enzyme and its primary catalytic activity of hydrolysis of oil triglycerides enables the liberation of diacylglycerides, monoglycerides, and/or fatty acids during fermentation that enhances recovery and/or separation of the valuable oil after fermentation and distillation, such as where centrifugation or other extraction techniques are used to recover some or most of the oil.

With the use of the particular class of lipase disclosed herein, preferably the primary mechanism occurring during the process is the hydrolysis of the triacylglycerol lipase. During hydrolysis and in the presence of water, the conversion to diacylglycerols and carboxylate fatty acids occurs.

A secondary mechanism that can occur is the hydrolysis of steryl esters that may be present. During this hydrolysis and in the presence of water, the conversion to sterols and fatty acids occurs.

A tertiary mechanism that may occur, especially if one or more oxidants are present during fermentation is a chemo-enzymatic epoxidation which requires an oxidant to produce the reaction in accompaniment with a lipase to initiate the peracid. Oxidants are not typically predominant in ethanol fermentation but have been used. As an example: Fatty acid+H₂O₂+Lipase→peracid+unsaturated oil→fatty acid+epoxide (oxirane).

After fermentation, the fermented product (e.g., alcohol such as ethanol) is separated from the mash such as by distillation. The remaining material (not separated from the mash), referred to sometimes as the stillage or whole stillage, can be subjected to a mechanical separation step(s) to substantially separate the liquid containing oil (sometimes referred to as thin stillage) from the solids (sometimes referred to as coarse grains or wet distillers grain). Oil recovery as mentioned in the present invention can occur from the whole stillage, and/or from the thin stillage, and/or from thin stillage subjected to an evaporator step(s) (sometimes referred to as condensed distillers solubles). In some instances, the primary oil recovery step occurs once thin stillage is formed or recovered, and the thin stillage is subjected to further mechanical separation steps, such as with a centrifuge.

An option for oil recovery after distillation and removal of the ethanol (or other alcohol product) is subjecting the whole stillage to a 3-phase decanter (also referred to as a tricanter) such as one from Flottweg or ICM Inc. The 3-phase decanter can separate the whole stillage into coarse solids, oil, and non-oil liquids (e.g. a water based phase or thin stillage). As an option, the recovered thin stillage can be further subjected to a centrifugal decanter or other phase separation technique to separate any remaining oil present in the thin stillage. As an option, the remaining thin stillage (with further oil removed or not) can be subjected to an evaporator to drive off at least some of the water and obtain the condensed product known as condensed distillers solubles. This condensed product, as an option, can be further subjected to separation techniques to recover further oil that may be remaining in the condensed product. A majority of the oil recovered can be obtained from the phase separation of the whole stillage. As an option, instead of a 3-phase decanter, a 2-phase decanter or centrifugal decanter can be utilized on the whole stillage to obtain the coarse solids and the thin stillage and then the thin stillage can be subjected to a centrifuge or other separation device to separate at least some of the oil in the thin stillage from the non-oil components.

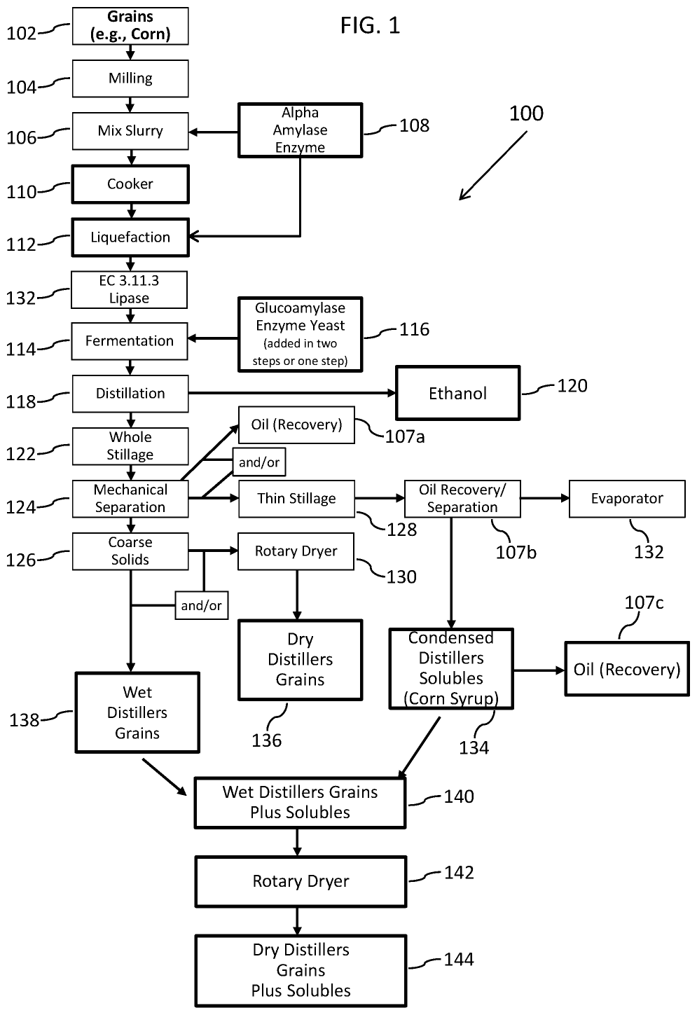

A further overview of the ethanol (or other fermentation product) (100) process is described below (with reference to FIG. 1) and then more details of the use of the lipase classified as EC 3.1.1.3 and the step of adding are described as well as a further description of the oil recovery step(s). The process and options described in U.S. Pat. No. 7,727,726 can be utilized, and this patent is incorporated in its entirety by reference herein.

In the present invention, when the biomass is a starch-containing material (i.e., a biomass containing starch or grains), such as corn, the method can further include, prior to adding the lipase to the biomass, converting at least a portion of the starch in the biomass into dextrins and then saccharifying the dextrins to form the sugar. When such steps are present, the adding of the at least one lipase occurs prior to or during fermenting, and preferably after the converting step and/or after the saccharifying step.

The biomass is generally grains (102) which can be corn (with corn oil being recovered). The biomass can be sugarcane, sunflowers, flaxseed, sugar beets and/or other plants and/or vegetables. The biomass can be algae.

The biomass that receives the lipase can be in the form of a biomass slurry. The biomass slurry can be formed by taking starting grains 102 (such as corn) and milling it 104 (such as using a hammermill or roller mill or other milling apparatus or technique) (e.g. using screens between 0.5 mm to 4 mm). Water can be added to the milled biomass to form a slurry 106 (e.g. a 20% to 40% solids such as about 30% solids) which can be placed in a cooker 110 and then afterwards, subjected to a liquefaction 112. The milled biomass (e.g., milled grains or milled corn) combined with water can be known as a mash. Once the slurry or mash 106 is made, the process generally involves cooking and liquefaction. The cooking stage 110 is also called gelatinization, and the water interacts with grains in the mash (e.g., the starch granules in the corn) when the temperature is >60° C. and forms a viscous suspension. The liquefaction step 112 can be considered a partial hydrolysis that lowers the viscosity of the suspension. It is essentially breaking up the longer starch chains into smaller chains. In order to accomplish liquefaction, the reaction takes place under certain conditions. Preferably, the pH of the mash is maintained in the pH range of from about 4.8 to about 6.2, and a base (e.g., ammonia) or an acid (e.g., sulfuric acid) are used/added to the tank to maintain the pH. A portion or more of starch converting enzyme, α-amylase 108, can be added to the mash prior to cooking (e.g., jet cooking) (e.g., 2-7 minutes at 105-120° C.) to improve flowability of the mash. The cooking can serve as a sterilization step to avoid bacterial contamination during the fermentation step later on. At this stage, shorter dextrins are produced, but are not yet glucose. The α-amylase for liquefaction acts on the internal α (1,4) glycosidic bonds to yield dextrins and maltose (glucose dimers).

Three types of processes can be utilized for liquefaction. The α-amylase can be added and the material is incubated at 85-95° C. The mash can be placed in cooker, such as a jet cooker at 105-120° C. for 2-7 minutes, then flows to a flash tank at 90° C. and the α-amylase can be added later, such as 2, 3 or more hours later. The third option, the α-amylase can be added and heated in the cooker at 150° C., followed by flow to the flash tank at 90° C. and adding more α-amylase.

The next step in the process is generally saccharification. Saccharification is the process of further hydrolysis to glucose monomers. A different enzyme is used, called a glucoamylase (optionally at 116) (also known as amyloglucosidase). It cleaves both the α (1,4) and α (1,6) glycosidic bonds from dextrin ends to form glucose. The optimum conditions are different from the previous step and are at a pH of from about 4.5 to about 5 and a temperature of 55-65° C. There are a wide variety of commercially available amylase enzymes available that are derived from bacteria and fungi.

Some of the developed enzymes (granular starch hydrolyzing enzymes—GSHE) allow skipping the liquefaction stage by hydrolyzing starch at low temperatures with cooking and this is an option in the processes of the present invention.

The saccharification step can occur prior to or at the same time as when yeast is added.

Afterwards, the biomass slurry can be subjected to the fermentation process 114 (such as in one or more fermentation tanks or vessels). To cause fermentation to take place, a fermenting organism, such as yeast is added 116. The fermenting organism can include, comprise, consists essentially of, or consists of at least one yeast.

Yeast is used for sake of illustration in some descriptions provided herein, but other host microorganisms may be used. The yeast that can be used in the culturing and fermenting steps can be any yeast used in fermenting. The yeast of choice is Saccharomyces cerevisiae, especially for corn grains. Examples include Saccharomyces cerevisiae, Saccharomyces pastorianus (carlsbergiensis), Kluyveromyces lactis, Kluyveromyces fragilis, Fusarium oxysporum, or any combination thereof. Culturing and fermenting can be performed using a mixture containing from about 0.01% to about 50.00% by weight of at least one yeast and from about 99.99% to about 50.00% by weight of the nutrient composition, or using a mixture containing from about 0.10% to about 25.0% by weight of at least one yeast and from about 0.10% to about 10.0% by weight of the nutrient composition, or other mixing amounts.

A common yeast to use is saccharomyces cerevisiae, which is a unicellular fungus. The reaction can, for example, occur at 30-32° C. for 2-3 days in a batch process. Supplemental nitrogen can be added as anhydrous ammonia, ammonium sulfate ((NH₄)₂SO₄) or urea. A protease can be used to convert proteins to amino acids to add as an additional yeast nutrient. Virginiamycin and penicillin can be used to prevent bacterial contamination. The carbon dioxide produced also lowers pH. In some processes, from about 90 to about 95 wt % of the glucose is converted to ethanol.

It is possible to do saccharification and fermentation in one step (shown as 116), known as Simultaneous Saccharification and Fermentation (SSF), and if done, both the glucoamylase and fermenting organism (e.g. yeast) are added together. It can be done at a lower temperature than saccharification (32-35° C.), which slows the hydrolysis into glucose. As the glucose is formed, it is fermented, which reduces enzyme product inhibition.

In more detail, the method can include, comprise, consists essentially of, or consists of: adding at least one lipase (132) classified as EC 3.1.1.3 to a biomass prior to or during a fermenting of the biomass, wherein the biomass comprises sugar converted from starch in the biomass. The method can further include fermenting (114) at least a portion of the sugar to obtain ethanol 120 and also obtain stillage 122.

The adding step with the lipase(s) can include, comprise, consists essentially of, or consists of mixing or combining the at least one lipase with the biomass and in the presence of a fermenting organism. The adding of the lipase can occur in any conventional technique of any enzymes in an ethanol forming process. The lipase can be added as a solid, or a slurry, or as a liquid to the bio-mass. After or during the adding of the lipase, the bio-mass (e.g., slurry of milled grains) can be subject to mixing using, for instance, a mixer. The adding of the lipase can occur after the biomass is subjected to a cooking stage (e.g., cooker). The adding of the lipase can occur after the biomass is subjected to a liquefaction stage. The adding of the lipase can occur right before the biomass is subjected to a fermentation (or right before being introduced into a fermenter). The adding of the lipase can occur while the biomass is subjected to a fermentation (or while being introduced into a fermenter). The adding of the lipase can occur right before or right after the introduction of an enzyme to convert the dextrins to sugars. The adding of the lipase can occur during the introduction of an enzyme to convert the dextrins to sugars. Regarding the adding locations or times, the adding of the lipase occurs when the temperature of the biomass or slurry of grains is below 80 deg C., such as from about 30 deg C. to about 50 deg C.

Any EC 3.1.1.3 lipase may be used in the indicated methods of the present invention. One or more such lipases can be used. If more than one type is used, the lipases can be introduced together or separately at the same or different locations. As stated, the lipases used are enzymes classified by EC 3.1.1.3. Reference is made to the Recommendations (1992) of the Nomenclature Committee of the international Union of Biochemistry and Molecular Biology, Academic Press Inc., 1992. Additional lipases and/or enzymes can be used in addition to the EC 3.1.1.3 lipase(s). The lipases can be derived or isolated from various fungi and/or bacteria, and/or other microorganisms, or from pancreatic sources (e.g., pancreatic lipase). As an option, the lipase can be of microbial origin, in particular of bacterial, fungal, or yeast origin. The lipase can be derived from any source, including, for example, a strain of Aspergillus, a strain of Achromobacter, a strain of Bacillus, a strain of Candida, a strain of Chromobacter, a strain of Pseudomonas, a strain of Rhizomucor, a strain of Rhizopus, or a strain of Thermomyces, or any combinations thereof.

The lipase is a triacyl glycerol lipase (TAG lipase) or triacylglycerol acylhydrolase lipase. Commercially available products containing this lipase can be used, such as BUZYME 13800 (available from Buckman Laboratories International, Inc.).

Total amounts of lipase that can be used in biomass slurry or mash to be fermented can be, for example, from about 0.01 ppm to about 500 ppm by weight, or from about 0.1 ppm to about 250 ppm by weight, or from about 1 ppm to about 100 ppm by weight, or from about 3 ppm to about 50 ppm by weight, or other amounts, in the biomass or biomass slurry.

As an option, the EC 3.1.1.3 lipase is used in the absence of any other enzyme or lipase (except for the fermenting organism). As an option, the EC 3.1.1.3 lipase is used in the absence of any phospholipases.

It is to be understood that the term lipase, can encompass wild-type lipase enzymes, as well as any variant thereof that retains the activity in question, such as chemically modified or protein engineered mutants. Such variants may be produced by recombinant techniques. The wild-type lipase enzymes may also be produced by recombinant techniques, or by isolation and purification from the natural source.

During the fermenting step, the EC 3.1.1.3 lipase can be the only enzyme component present or can be the major or minor component if added in combination with optional different enzymes to the fermentation tank (for instance, the EC 3.1.1.3 lipase can be present in an amount (based on total enzymes present in the fermentation tank) of at least 5 wt %, at least 10 wt %, at least 15 wt %, at least 25 wt %, at least 35 wt %, at least 50 wt %, at least 75 wt %, at least 90 wt % such as from about 1 wt % to 99.9 wt % of all enzymes present used in the fermentation tank). The lipase can be a well-defined, or purified, or highly purified lipase. Examples of enzymes that may be present with the lipase include glycoamylase, a protease, alpha amylase, trehalase, phytase, phospholipase, and the like. More generally, enzymes that may optionally be used as additional enzymes may be, for example, protease, xylanase, cutinase, oxidoreductase, cellulose endoglucanase, amylase, mannanase, steryl esterase, and/or cholesterol esterase activity, or any combinations thereof. Multiple enzymes, if used, can be added as part of a pre-mixture, added separately, or added in any order. In addition to the enzymatic activity, at least one adjuvant can be used with the lipase. Examples of adjuvants, which can be used in enzyme preparations are, for example, buffers, polymers, surfactants and/or stabilizing agents.

As an option, the EC 3.1.1.3 lipase can be used (e.g. introduced into the fermenter or used during fermentation) in combination with one or more other enzymes and/or in combination with one or more separation aids (which can be liquid(s) and/or solids (e.g. particulates). As an option, the EC 3.1.1.3 lipase can be immobilized and this can even be achieved with a separation aid (e.g. a particulate one) that can serve dual purposes—immobilization and separation aid. Discussions and examples of separation aids, as described herein and later, can be used with the EC 3.1.1.3 lipase as a formulation that is introduced or used during fermentation.

The stillage byproduct can be whole stillage 122, thin stillage 128, and also syrup 134 from the evaporator 132. As generally known, thin stillage is recovered by separating the distillers wet grain from the “whole stillage” leftover after fermentation is complete. As also generally known in the art, this mechanical separation 124 may be accomplished using a press/extruder, a 2-phase or 3-phase decanter centrifuge (also simply known as a “decanter”), or a screen centrifuge. Moisture can then be removed from the unfiltered thin stillage to create a concentrate or syrup, such as through evaporation. As an option, one or more separation aids can be added to the stillage after recovering the stillage that contains oil from the ethanol and stillage and before recovering at least a portion of the oil from the stillage. As an option, the separation aid(s) can include, comprise, consists essentially of, or consists of at least one surfactant. The use of one or more separation aids can be utilized as an option prior to any oil separation stage or step to potentially enhance oil recovery.

The use of a separation aid can make it easier to recover usable oil from the whole stillage, thin stillage, or syrup (concentrate), or any combinations thereof, without the need to pressure cook the stillage or use multiple stages of filtration that may be expensive and complicated forms of processing.

Referring further to FIG. 1, a process 100 for the production of ethanol biofuel and byproducts from biomass, such as corn, includes bio-oil recovery 107 from stillage. Several process byproducts 122, 128, 134 are identified in this figure for purposes of exemplifying various types of “stillage” that may be used for use as feedstock in oil recovery—107a, 107b, and 107c. As indicated in FIG. 1, following distillation, the whole stillage 122 is separated, such as with a centrifuge 124, such as a decanter centrifuge, into wet grains 126 and thin stillage 128 or into wet grains 126/138, oil 107a, and thin stillage 128. The thin stillage 128 can be subjected to an oil separation step 107b to recover oil present in the thin stillage 128. Evaporator 108 can concentrate thin stillage 128 (either subjected to or not to oil extraction—107b) into syrup 134 by evaporation, and the syrup 134 can be combined with wet grains 138 to produce distiller grains and solubles (DGS) 140, or can be dried to produce distiller dried grains and solubles (DDGS) 144, or both. Corn is shown as the biomass material in FIG. 1 for sake of illustration, and other biomass materials can be used, such as other fermentable starch-containing biomass materials.

In a process flow, the stillage can have a solids content, for example, of below 30 wt %, or from about 5 wt % to about 20 wt %, or from about 7 wt % to about 18 wt %, or other values (based on the weight of the stillage). Optionally, a separation aid can be mixed with stillage before introduction to any mechanical separation (e.g., decanter or centrifuge step), before introduction to any evaporator, or added to the stillage at or between any evaporators of a multi-stage evaporator (if used), or any combinations of these. The separation aid can be added predominantly during one or more intermediate stages of a multi-stage evaporator (if used).

One or more surfactants can optionally be used as part of a separation aid composition. The surfactant can be, for example, nonionic surfactants, cationic surfactants, or anionic surfactants. The surfactant (which can be one or more) can be a nonionic surfactant, for example, ethoxylated castor oil, an ethoxylated sorbitan ester, a PEG, a poloxamer, an acetylenic glycol, or a sulfonate, or combinations thereof. The nonionic surfactants can be, for example, nonionic polyethylene glycols, such as ethoxylate of carboxylic acids, ethoxylate of mono-, di- or triglycerides, ethoxylate of mono-, di- or triesters of sorbitan or ethoxylate of fatty alcohols. The ethoxylated sorbitan esters can be commercially obtained as TWEEN or polysorbate series surfactant. Other suitable nonionic surfactants are mono-, di- or triglycerides based on fatty acids having 12-22 carbon atoms, or mono-, di- or triesters of sorbitan based on fatty acids having 12-22 carbon atoms. Commercial sources of the nonionic surfactant which can be used in separation aids of the present invention include, for example, Lumisorb Polysorbates from Lambent Technologies Corporation (Gurnee, Ill. USA). The nonionic surfactant may be at least one poloxamer. Poloxamers can be nonionic triblock copolymers that comprise a central block of a hydrophobic polyalkyleneoxide block, which is flanked on both sides with hydrophilic polyalkyleneoxide blocks. Poloxamers are commercially available that are food grade. A commercial source of poloxamers are, for example, PLURONIC® copolymers from BASF Corporation (Florham Park, N.J., U.S.A.).

The water solubility of the surfactants, such as the nonionic surfactants, can be related to their hydrophilic-lipophilic balance (HLB) value or number. The nonionic surfactants can have an HLB value of at least about 6, or at least about 9, or at least about 12, or from about 6 to 20, or from about 7 to about 19, or from about 8 to about 18, or from about 9 to about 17, or from about 10 to about 16, or other values. The water solubility of nonionic surfactants can be related to their hydrophilic-lipophilic balance (HLB) value or number. The HLB value can be calculated in a conventional manner. For example, the HLB value of a nonionic surfactant can be calculated by dividing the molecular weight percent of the hydrophilic portion of the nonionic surfactant by five. For example, a nonionic surfactant containing 80 mole % hydrophilic portion (total) would have an HLB value calculated to be 16 (i.e., 80/5=16). HLB values that exceed 20 are relative or comparative values.

The separation aid can include organic and/or inorganic aids, such as particulate material(s). Examples include, but are not limited to, fumed silica, precipitated silica, colloidal silica, talc, clay, diatomaceous earth, titanium dioxide, zinc oxide, iron oxide, aluminum oxide, aluminum hydroxide, cerium oxide, zirconium oxide, calcium stearate, zeolite, celluloses and derivatives thereof, polymethyl methacrylates, polymethacrylates, polystyrenes, or polyacrylates and derivatives thereof, or any combinations thereof. The particulate material can be hydrophobic or hydrophilic. The above particulate material can be sized from about 0.1 nanometer to about 1000 micron and used in an amount, for example, of from about 1 wt % to 30 wt % based on the overall weight of the separation aid formulation.

The present invention has many advantages and capabilities. Any one or more of the following advantages, capabilities, and/or properties can be achieved or present with the present invention.

With the present invention, the amount of bio-oil (e.g. grain oil) recovered can be increased or improved during the oil recovery process.

With the present invention, the amount of oil recovery aids (e.g., separation aids) for oil recovery can be reduced or eliminated. For instance, the amount of oil recovery aids (e.g., added for instance to the stillage prior to separation steps) can be reduced by 10%, reduced by 20%, reduced by 50%, reduced by 75%, reduced by 90%, or completely eliminated, with the % based on the total volume or weight percent of the total amount of recovery aids used for oil recovery steps.

With the present invention, the method has the ability to release less organic and/or inorganic phosphate into the mash or slurry. Organic and/or inorganic phosphates can cause fouling of equipment such as evaporator fouling of the industrial cooling equipment. For instance, the amount of reduction in organic and/or inorganic phosphates can be reduced by 10%, reduced by 20%, reduced by 50%, reduced by 75%, reduced by 90%, or completely eliminated, with the % is wt % and based on the total phosphates released by weight.

With the present invention, the probability of the darkening oil, and/or wet cake, and/or syrup, and/or distillers dried grains is reduced due to the chemistry utilized in the method of the present invention, and thus helping the quality of animal feed recovered.

With the present invention, the method can be utilized or practiced in the presence of one or more oxidants which may be incorporated into the fermentation process. No negative or serious side effects or reactions occur.

With the present invention, the method can be utilized or practiced in the presence of one or more non-ionic surfactants for enhanced oil recovery following fermentation. While separation aids may not be needed in the methods of the present invention (as an option), if a separation aid is used or a reduced amount of separation aid, the methods of the present invention can make use of non-ionic surfactants.

With the present invention, the method has the ability, in some embodiments, to diminish unwanted and harmful acetic and lactic acids in the fermentation process. For instance, the amount of reduction in acetic acid and/or lactic acid can be by 10%, reduced by 20%, reduced by 50%, reduced by 75%, reduced by 90% or more, with the % as wt % and based on total acetic acid and/or acetic acid produced based on a control (with no lipase used).

With the present invention, the methods of the present invention can generate amounts (such as modest amounts) of glycerol. The presence of glycerol (such as 5 ppm to 500 ppm) in the slurry or mash prior to fermentation can have the ability to assist in reducing stress from heat upon fermenting organisms, such as genetically modified yeasts.

With the present invention, the methods of the present invention can assist in reducing the amounts of protease, and/or xylanase, and/or cellulase, and/or hemicellulases, and/or phytases and/or other hemicellulases used in the fermentation process for oil recovery. With the present invention, one, two, three, four, five, or all six of these can be completely eliminated (not used) in the method or can be reduced, such as at least a 10 wt %, or at least 25 wt %, at least 50 wt %, at least 75 wt %, or at least 90 wt % or more reduction based on amounts conventionally used or based on amounts that would be used to achieve the same amount of oil recovery but without the lipase of the present invention being used.

With the present invention, the methods of the present invention have the ability to enhance the quality of fatty acid methyl esters (FAMES) fatty acids and/or oil for use in processing biodiesel.

With the present invention, without being bound by to any one theory, the use of the particular lipase promotes or is involved in the destabilization of the protein shell that emulsifies oil.

With the present invention, without being bound to any one theory, the use of the particular lipase provides competition or competes with proteins for sugars.

With the present invention, without being bound by to any one theory, the use of the particular lipase provides for a reduction in evaporator fouling due to the surface activity of liberated fatty acids and/or inhibitions of protein/sugar associations.

The present invention will be further clarified by the following examples, which are intended to be only exemplary of the present invention. Unless indicated otherwise, all amounts, percentages, ratios and the like used herein are by weight.

### EXAMPLES

### Example 1

Bench testing was performed on slurry corn mash prepared in the laboratory in large 5 gallon containers. The dry milled corn grain was prepared so as to have a to 28 wt % solids in make up water. During the cook, the starch gradually became gelatinized and was appropriately saccharified with alpha amylase at 1.0 gram and then glucoamylase at 0.5 gram per 5.0 gallons of mash. The process of saccharification broke down the complex carbohydrate to simple glucose sugar. After cooling to about 30° C. to 33° C., urea was added in the amount of 15 grams to the entire 5 gallons of saccharified slurry mash as a nitrogen source. The initial pH was 5.3 of the mash. Saccharomyces cerevisiae yeast was added in an amount of approximately 5×10⁷ colony forming units cells per ml of slurry mash. In this example, different types of enzymes were added to separate flasks in the activity amount of 1.5 (U) units per gram of mash. Controls were also used that contained no enzyme treatment. The mash was dispensed by equal weight into liter flasks in amounts of 300 grams each and placed in a rotary incubator at 100 rpm at 30 deg C. for 60 hours of fermentation time. All flasks were capped appropriately. This procedure was performed for each of three separate trials. Three different types of comparative phospholipase enzymes were used and identified as ENZ A, ENZ B and ENZ C (each of ENZ A, ENZ B and ENZ C are from three different suppliers and are each different types of phopholipases). The fourth enzyme was the triacylglycerol lipase of the present invention named BM Lipase which was a commercial grade BUZYME 13800 from Buckman Laboratories International, Inc. A control with no lipase (or enzyme) was included.

The objective of this bench top testing was to compare various enzyme extractions of corn oil from mash in the absence of any added separation aid other than centrifugation. The total oil extracted from each sample was determined by first homogenizing each sample by shaking vigorously prior to weighing out samples. 10 grams of stillage was weighed out for each sample put in a 50 mL centrifuge tube. Each tube with sample was vortexed and then the tubes were centrifuged at 4000 rpms for 5 mins. The liquid layer(s) formed are removed from the tubes and then subjected to vacuum evaporation using a RapidVap evaporator. Following evaporation, the amount of the separated oil recovered is measured as milliliters of corn oil. These evaluations were performed for each of three separate trials.

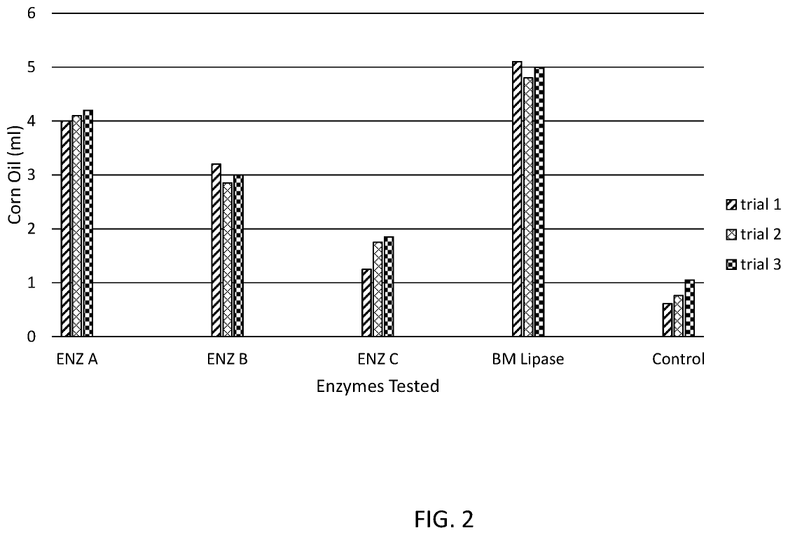

The results of these trial evaluations are indicated in FIG. 2. These results show that the use of triacylglycerol lipase released more corn oil than any of the separate phospholipase types in the absence of any separation aid other than centrifugation.

### Example 2

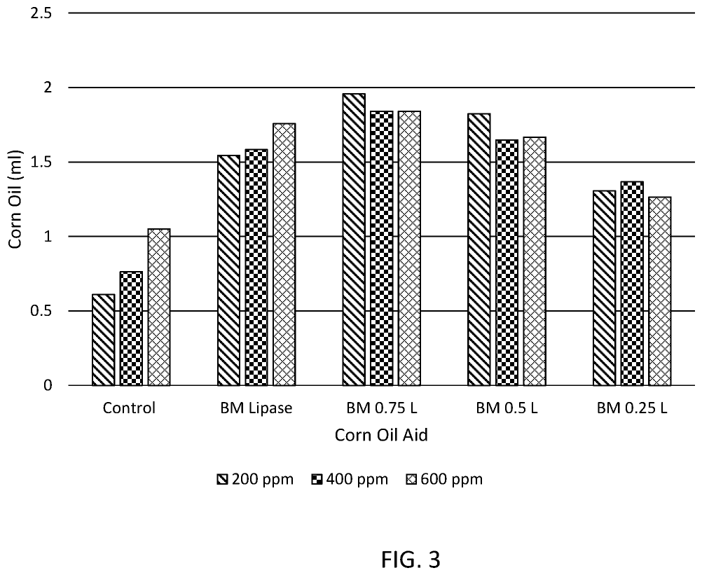

A sample slurry mash was prepared as in Example 1 with the exception that only the triacylglycerol lipase of the present invention was evaluated by using various dosages of the lipase along with a control (no enzyme treatment). Appropriate multiple trial flasks were set up as in Example 1. The objective was to evaluate if the effectiveness of triacylglycerol lipase (BM lipase) with respect to dose levels—BM lipase at 2.0 units per gm/ml mash, BM 0.75 L (1.5 units per gm/ml mash), BM 0.5 L (1.0 units per gm/ml mash), BM 0.25 L (0.5 units per gm/ml mash) and control (no enzyme). 100 gm of each 300 gm mash flask was evaluated for amounts (in ml) of corn oil recovered. The total oil extracted from each sample was determined by first homogenizing each sample by shaking vigorously prior to weighing out samples. 10 grams of stillage was weighed out for each sample put in a 50 mL centrifuge tube. Each centrifuge tube was filled up to the 45 mL mark with a solvent blend of 80 wt % hexane and 20 wt % ethanol. Each tube with sample was vortexed to disperse the solvent and then the tubes were centrifuged at 4000 rpms for 5 mins. The liquid layers formed are removed from the tubes and then subjected to vacuum evaporation using a RapidVap evaporator. Following evaporation, the amount of the separated oil recovered is measured as milliliters of corn oil. These evaluations were performed for each of three separate trials. The results of these evaluations are shown in FIG. 3.

These results indicate that the optimal dosage of the triacylglycerol lipase is about 1.5 units per gm/ml of mash. It should be noted, however, that the use of triacylglycerol lipase at all doses tested significantly enhanced corn oil recovery over the control which had the extraction aid only. Dosage amounts below 0.5 U and above 2 U per gram/ml mash are also considered effective in extracting more oil than the control (with no lipase or other enzyme).

The present invention includes the following aspects/embodiments/features in any order and/or in any combination:
1. The present invention relates to a method for bio-oil recovery from a fermentation process, comprising

a) adding at least one lipase classified as EC 3.1.1.3 to a biomass prior to or during a fermenting of the biomass, wherein said biomass comprises sugar converted from starch in the biomass.

b) fermenting at least a portion of the sugar to obtain ethanol and stillage,

c) recovering the stillage that contains oil from said ethanol and stillage, and

d) recovering at least a portion of the oil from the stillage.
2. The method of any preceding or following embodiment/feature/aspect, wherein said adding comprises mixing the at least one lipase with the biomass and in the presence of a fermenting organism.
3. The method of any preceding or following embodiment/feature/aspect, further comprising adding at least one separation aid to said stillage after step c) and before step d).
4. The method of any preceding or following embodiment/feature/aspect, wherein said at least one separation aid comprises at least one surfactant.
5. The method of any preceding or following embodiment/feature/aspect, wherein said method further comprises, prior to step a), converting at least a portion of said starch in said biomass into dextrins and then saccharifying the dextrins to form said sugar.
6. The method of any preceding or following embodiment/feature/aspect, wherein said adding of said at least one lipase occurs prior to step a), after said converting or after said saccharifying, or both.
7. The method of any preceding or following embodiment/feature/aspect, wherein said lipase comprises a triacyl glycerol lipase.
8. The method of any preceding or following embodiment/feature/aspect, wherein said lipase is present in an amount of from about 0.5 U to about 2 U in a vessel fermentation medium, wherein U is an enzyme unit for the amount of the enzyme that catalyzes the conversion of 1 micro-mole of triglyceride in a fermentation medium per ml of mash in the fermenter per minute.
9. The method of any preceding or following embodiment/feature/aspect, wherein said biomass in step a) is in the form of a biomass slurry.
10. The method of any preceding or following embodiment/feature/aspect, wherein said biomass is corn and said oil is corn oil.
11. The method of any preceding or following embodiment/feature/aspect, wherein said fermenting organism comprises at least one yeast.
12. The present invention further relates to a method to increase oil recovery resulting from a biomass fermentation process, said method comprising adding at least one lipase classified as EC 3.1.1.3 to a biomass prior to or during a fermenting of the biomass, wherein said biomass comprises sugar converted from starch in the biomass.
13. The method of any preceding or following embodiment/feature/aspect, wherein said oil recovery is increased by at least 5% by volume, compared to a biomass fermentation process that is the same except for the absence of said at least one lipase.
14. The method of any preceding or following embodiment/feature/aspect, wherein said recovering is step d) is in the absence of any oil separation aid in the stillage.
15. The method of any preceding or following embodiment/feature/aspect, wherein the biomass comprises or is algae.
16. The method of any preceding or following embodiment/feature/aspect, wherein biomass comprises or is one or more types of grains.
17. The method of any preceding or following embodiment/feature/aspect, wherein the lipase is or includes an immobilized lipase.

The present invention can include any combination of these various features or embodiments above and/or below as set forth in sentences and/or paragraphs. Any combination of disclosed features herein is considered part of the present invention and no limitation is intended with respect to combinable features.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for bio-oil recovery from a fermentation process, comprising
a) adding at least one lipase classified as EC 3.1.1.3 to a biomass prior to or during a fermenting of the biomass, wherein said biomass comprises sugar converted from starch in the biomass.
b) fermenting at least a portion of the sugar to obtain ethanol and stillage,
c) recovering the stillage that contains oil from said ethanol and stillage, and
d) recovering at least a portion of the oil from the stillage.

2. The method of claim 1, wherein said adding comprises mixing the at least one lipase with the biomass and in the presence of a fermenting organism.

3. The method of claim 1, further comprising adding at least one separation aid to said stillage after step c) and before step d).

4. The method of claim 3, wherein said at least one separation aid comprises at least one surfactant.

5. The method of claim 1, wherein said method further comprises, prior to step a), converting at least a portion of said starch in said biomass into dextrins and then saccharifying the dextrins to form said sugar.

6. The method of claim 5, wherein said adding of said at least one lipase occurs prior to step a), after said converting or after said saccharifying, or both.

7. The method of claim 1, wherein said lipase comprises a triacyl glycerol lipase.

8. The method of claim 1, wherein said lipase is present in an amount of from about 0.5 U to about 2 U in a vessel fermentation medium, wherein U is an enzyme unit for the amount of the enzyme that catalyzes the conversion of 1 micro-mole of triglyceride in a fermentation medium per ml of mash in the fermenter per minute.

9. The method of claim 1, wherein said biomass in step a) is in the form of a biomass slurry.

10. The method of claim 1, wherein said biomass is corn and said oil is corn oil.

11. The method of claim 2, wherein said fermenting organism comprises at least one yeast.

12. A method to increase oil recovery resulting from a biomass fermentation process, said method comprising adding at least one lipase classified as EC 3.1.1.3 to a biomass prior to or during a fermenting of the biomass, wherein said biomass comprises sugar converted from starch in the biomass.

13. The method of claim 12, wherein said oil recovery is increased by at least 5% by volume, compared to a biomass fermentation process that is the same except for the absence of said at least one lipase.

14. The method of claim 1, wherein said recovering is step d) is in the absence of any oil separation aid in the stillage.

15. The method of claim 1, wherein said biomass comprises algae.

16. The method of claim 1, wherein said biomass comprises one or more types of grains.
